(19) United States
(12) Patent Application Publication
(10) Pub. No.: US 2022/0063653 A1
(43) Pub. Date: Mar. 3, 2022

(54) SELECTING AN AUTONOMOUS VEHICLE FROM A SET OF AUTONOMOUS VEHICLES

(71) Applicant: HERE Global B.V., Eindhoven (NL)

(72) Inventors: Jerome BEAUREPAIRE, Berlin (DE); Leon STENNETH, Chicago, IL (US); Jeremy Michael YOUNG, Chicago, IL (US)

(21) Appl. No.: 17/090,437

(22) Filed: Nov. 5, 2020

Related U.S. Application Data
(60) Provisional application No. 63/071,112, filed on Aug. 27, 2020.

(51) Int. Cl. B60W 60/00; G06N 20/00; G01C 21/34; B60W 50/14; G01C 21/36; G08G 1/00

(52) U.S. Cl. CPC B60W 60/001; G06N 20/00; G01C 21/3453; B60W 50/14; B60W 2556/65; G01C 21/3415; G01C 21/3691; G08G 1/22; G01C 21/3626

(57) ABSTRACT

A method, apparatus and computer program product are provided to facilitate autonomous vehicle selection based on the vehicle's ability to navigate autonomous transition regions along a particular route comprising at least one autonomous transition region. In context of a method, the method receives a route request comprising an origin location and a destination location and determines, based at least on the route request, one or more candidate routes. For a respective candidate route, the method analyzes the respective candidate route based upon one or more autonomous transition region parameters, and causes transmission of information relating to the respective candidate route based upon the analyzing of the respective candidate route and the one or more autonomous transition region parameters associated therewith.

### CROSS-REFERENCE TO RELATED APPLICATIONS

This application claims the benefit of U.S. Provisional Patent Application No. 63/071,112, filed Aug. 27, 2020, the entire contents of which are incorporated herein by reference.

### BACKGROUND

An autonomous vehicle is a vehicle including automated mechanisms for performing one or more aspects of vehicle control that have been conventionally performed by the driver. As autonomous vehicles are adopted, several benefits may be realized. For example, vehicle collisions may be reduced because computers can perform driving tasks more consistently and make fewer errors than human operators.

However, in certain regions, autonomous functionalities of a particular vehicle may not be suitable and the vehicle may be required to disengage from autonomy and instead be controlled in a different manner, such as by relying on manual human intervention for a period of time. If many autonomous vehicles are disengaging from autonomy in a particular region, the region may become congested, and a passenger's ride experience may suffer. In this regard, a region may become congested as drivers take time to assume control and to familiarize themselves with the vehicle which, in some instances, e.g., in conjunction with ride share services, the driver may not have previously driven. The region may also become congested in instances in which a vehicle that has disengaged waits for a platoon leader capable to autonomously navigating the region to arrive and lead the vehicle.

### BRIEF SUMMARY

A method, apparatus and computer program product are therefore provided in accordance with an example embodiment in order to facilitate autonomous vehicle selection based on the vehicle's ability to navigate autonomous transition regions along a particular route comprising at least one autonomous transition region. By identifying and determining parameters of autonomous transition regions along a given route, suitable autonomous vehicles for a particular journey may be identified in a more efficient manner, thereby leading to an overall improved passenger experience including reduced travel time and costs.

In an example embodiment, an apparatus is provided that includes at least one processor and at least one memory storing computer program code with the at least one memory and the computer program code configured to, with the processor, cause the apparatus to at least receive a route request comprising an origin location and a destination location. The at least one memory and the computer program code are also configured to, with the processor, cause the apparatus to determine, based at least on the route request, one or more candidate routes. The at least one memory and the computer program code are also configured to, with the processor, cause the apparatus to, for a respective candidate route of the one or more candidate routes, determine a respective route transition score, such as a route disengagement score, based at least on one or more autonomous transition regions, such as one or more disengagement regions, associated with the respective candidate route. The at least one memory and the computer program code are also configured to, with the processor, cause the apparatus to cause transmission of at least one candidate route and a transition indication, such as the route transition score, e.g., the associated route disengagement score, to a user interface.

The at least one memory and the computer program code of an example embodiment are further configured to, with the processor, cause the apparatus to determine, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason. The respective route disengagement score is determined using one or more of the disengagement region parameters.

The at least one memory and the computer program code of an example embodiment are further configured to, with the processor, cause the apparatus to determine, for at least one candidate route following determination of the respective route transition score using the one or more autonomous transition region parameters, an updated plurality of autonomous transition region parameters. The at least one memory and the computer program code of an example embodiment are further configured to, with the processor, cause the apparatus to determine an updated route transition score for the at least one candidate route based on the updated plurality of autonomous transition region parameters.

In some embodiments of the apparatus, the updated route transition score is determined periodically based on a preconfigured time interval. In some embodiments of the apparatus, the updated route transition score is determined in response to an autonomous level transition of one or more vehicles associated with the candidate route.

The at least one memory and the computer program code of an example embodiment are further configured to, with the processor, cause the apparatus to, based on the one or more candidate routes, cause information to be provided regarding one or more vehicles. The information comprises capability data of a respective vehicle to maneuver the respective candidate route. The at least one memory and the computer program code of an example embodiment are further configured to, with the processor, cause the apparatus to cause transmission of the information to the user interface.

The at least one memory and the computer program code of an example embodiment are further configured to, with the processor, cause the apparatus to, based at least on the capability data of two or more vehicles, determine a combination of the two or more vehicles to be utilized to traverse one of the at least one candidate routes. In this example embodiment, each of the two or more vehicles is to be utilized for a different respective portion of the one candidate route.

In some embodiments of the apparatus, the capability data comprises at least one of a cost value, a travel time, or one or more disengagement capabilities for the respective vehicle.

In an example embodiment, a method is provided that includes receiving a route request comprising an origin location and a destination location. The method also includes determining, based at least on the route request, one or more candidate routes. The method also includes, for a respective candidate route of the one or more candidate routes, determining a respective route transition score, such as a route disengagement score, based at least on one or more autonomous transition regions, such as one or more disengagement regions, associated with the respective candidate route. The method also includes causing transmission of at least one candidate route and a transition indication, such as the route transition score, e.g., the associated route disengagement score, to a user interface.

The method of an example embodiment also includes determining, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason. The respective route disengagement score is determined using one or more of the disengagement region parameters.

The method of an example embodiment also includes determining, for at least one candidate route following determination of the respective route transition score using the one or more autonomous transition region parameters, an updated plurality of autonomous transition region parameters. The method of an example embodiment also includes determining an updated route transition score for the at least one candidate route based on the updated plurality of autonomous transition region parameters.

In some embodiments of the method, the updated route transition score is determined periodically based on a preconfigured time interval. In some embodiments of the method, the updated route transition score is determined in response to an autonomous level transition of one or more vehicles associated with the candidate route.

The method of an example embodiment also includes, based on the one or more candidate routes, causing information to be provided regarding one or more vehicles. The information comprises capability data of a respective vehicle to maneuver the respective candidate route. The method of an example embodiment also includes causing transmission of the information to the user interface.

The method of an example embodiment also includes, based at least on the capability data of two or more vehicles, determining a combination of the two or more vehicles to be utilized to traverse one of the at least one candidate routes. In this example embodiment, each of the two or more vehicles is to be utilized for a different respective portion of the one candidate route.

In some embodiments of the method, the capability data comprises at least one of a cost value, a travel time, or one or more disengagement capabilities for the respective vehicle.

In an example embodiment, an apparatus is provided that includes means for receiving a route request comprising an origin location and a destination location. The apparatus also includes means for determining, based at least on the route request, one or more candidate routes. The apparatus also includes means for determining, for a respective candidate route of the one or more candidate routes, a respective route transition score, such as a route disengagement score, based at least on one or more autonomous transition regions, such as one or more disengagement regions, associated with the respective candidate route. The apparatus also includes means for causing transmission of at least one candidate route and a transition indication, such as the associated route transition score, e.g., the route disengagement score, to a user interface.

The apparatus of an example embodiment also includes means for determining, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason. In this example embodiment, the respective route disengagement score is determined using one or more of the disengagement region parameters.

The apparatus of an example embodiment also includes means for determining, for at least one candidate route following determination of the respective route transition score using the one or more autonomous transition region parameters, an updated plurality of autonomous transition region parameters. The apparatus of an example embodiment also includes means for determining an updated route transition score for the at least one candidate route based on the updated plurality of autonomous transition region parameters.

In some embodiments of the apparatus, the updated route transition score is determined periodically based on a preconfigured time interval. In some embodiments of the apparatus, the updated route transition score is determined in response to an autonomous level transition of one or more vehicles associated with the candidate route.

The apparatus of an example embodiment also includes means for causing, based on the one or more candidate routes, information to be provided regarding one or more vehicles. The information comprises capability data of a respective vehicle to maneuver the respective candidate route. The apparatus of an example embodiment also includes means for causing transmission of the information to the user interface.

The apparatus of an example embodiment also includes means for determining, based at least on the capability data of two or more vehicles, a combination of the two or more vehicles to be utilized to traverse one of the at least one candidate routes. In this example embodiment, each of the two or more vehicles is to be utilized for a different respective portion of the one candidate route.

In some embodiments of the apparatus, the capability data comprises at least one of a cost value, a travel time, or one or more disengagement capabilities for the respective vehicle.

In a further example embodiment, a computer program product is provided that includes a non-transitory computer readable medium having program code portions stored thereon with the program code portions being configured, upon execution, to receive a route request comprising an origin location and a destination location. The program code portions are also configured to determine, based at least on the route request, one or more candidate routes. The program code portions are also configured to determine, for a respective candidate route of the one or more candidate routes, a respective route transitions score, such as a route disengagement score, based at least on one or more autonomous transition regions, such as disengagement regions, associated with the respective candidate route. The program code portions are also configured to cause transmission of at least one candidate route and a transition indication, such as the associated route transition score, e.g., the associated route disengagement score, to a user interface.

The program code portions of an example embodiment are also configured to determine, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason. In this example embodiment, the respective route disengagement score is determined using one or more of the disengagement region parameters.

The program code portions of an example embodiment are also configured to determine, for at least one candidate route following determination of the respective route transition score using the one or more autonomous transition region parameters, an updated plurality of autonomous transition region parameters. The program code portions of an example embodiment are also configured to determine an updated route transition score for the at least one candidate route based on the updated plurality of autonomous transition region parameters.

In some embodiments of the computer program product, the updated route disengagement score is determined periodically based on a preconfigured time interval. In some embodiments of the computer program product, the updated route disengagement score is determined in response to an autonomous level transition of one or more vehicles associated with the candidate route.

The program code portions of an example embodiment are also configured to cause, based on the one or more candidate routes, information to be provided regarding one or more vehicles. The information comprises capability data of a respective vehicle to maneuver the respective candidate route. The program code portions of an example embodiment are also configured to cause transmission of the information to the user interface.

The program code portions of an example embodiment are also configured to determine, based at least on the capability data of two or more vehicles, a combination of the two or more vehicles to be utilized to traverse one of the at least one candidate routes. In this example embodiment, each of the two or more vehicles is to be utilized for a different respective portion of the one candidate route.

In some embodiments of the computer program product, the capability data comprises at least one of a cost value, a travel time, or one or more disengagement capabilities for the respective vehicle.

In a further example embodiment, a method is provided that includes receiving a route request comprising an origin location and a destination location. The method also includes determining, based at least on the route request, one or more candidate routes. The method also includes, for a respective candidate route of the one or more candidate routes that has at least one disengagement region, analyzing the respective candidate route based upon one or more autonomous transition region parameters, such as one or more disengagement region parameters. The method also includes causing transmission of information relating to the respective candidate route based upon the analyzing of the respective candidate route and the one or more autonomous transition region parameters, such as one or more disengagement region parameters, associated therewith.

In some embodiments of the method, analyzing the respective candidate route based upon the one or more autonomous transition region parameters further comprises determining a respective route transition score, such as a route disengagement score, using the one or more autonomous transition region parameters.

The method of an example embodiment also includes determining, for at least one candidate route following determination of the respective route transition score using the one or more autonomous transition region parameters, an updated plurality of autonomous transition region parameters. The method of an example embodiment also includes determining an updated route transition score for the at least one candidate route based on the updated one or more autonomous transition region parameters. In some embodiments of the method, the updated route disengagement score is determined in response to an autonomous level transition of one or more vehicles associated with the candidate route.

The method of an example embodiment also includes, based on the one or more candidate routes, causing information to be provided regarding one or more vehicles. The information comprises capability data of a respective vehicle to maneuver the respective candidate route. The method of an example embodiment also includes causing transmission of the information to a user interface.

The method of an example embodiment also includes determining, based at least on the capability data of two or more vehicles, a combination of the two or more vehicles to be utilized to traverse one of the at least one candidate routes. In this example embodiment, each of the two or more vehicles is to be utilized for a different respective portion of the one candidate route. In some embodiments of the method, the capability data comprises at least one of a cost value, a travel time, or one or more disengagement capabilities for the respective vehicle. In some embodiments of the method, the autonomous transition region parameters includes an indication of delay associated with one or more disengagement regions and the indication of delay further comprises one or more of a current disengagement index value, a disengagement start location, a severity categorization, a number of vehicles currently disengaged within the disengagement region, or a current wait time.

In a further example embodiment, an apparatus is provided that includes at least one processor and at least one memory storing computer program code with the at least one memory and the computer program code configured to, with the processor, cause the apparatus to at least receive a route request comprising an origin location and a destination location. The at least one memory and the computer program code are also configured to, with the processor, cause the apparatus to determine, based at least on the route request, one or more candidate routes. The at least one memory and the computer program code are also configured to, with the processor, cause the apparatus to, for a respective candidate route of the one or more candidate routes that has at least one autonomous transition region, such as at least one disengagement region, analyze the respective candidate route based upon a plurality of autonomous transition region parameters, such as a plurality of disengagement region parameters. The at least one memory and the computer program code are also configured to, with the processor, cause the apparatus to cause transmission of information relating to the respective candidate route based upon the analyzing of the respective candidate route and the plurality of autonomous transition region parameters, such as the plurality of disengagement region parameters, associated therewith.

In some embodiments of the apparatus, the at least one memory and the computer program code are also configured to, with the processor, cause the apparatus to determine a respective route transition score using one or more of the plurality of autonomous transition region parameters with respect to analyzing the respective candidate route based upon one or more autonomous transition region parameters.

The at least one memory and the computer program code of an example embodiment are further configured to, with the processor, cause the apparatus to determine, for at least one candidate route following determination of the respective route transition score using the one or more autonomous transition region parameters, an updated one or more autonomous transition region parameters. The at least one memory and the computer program code of an example embodiment are further configured to, with the processor, cause the apparatus to determine an updated route transition score for the at least one candidate route based on the updated one or more autonomous transition region parameters. In some embodiments of the apparatus, the updated route transition score is determined in response to an autonomous level transition of one or more vehicles associated with the candidate route.

The at least one memory and the computer program code of an example embodiment are further configured to, with the processor, cause the apparatus to, based on the one or more candidate routes, cause information to be provided regarding one or more vehicles. The information comprises capability data of a respective vehicle to maneuver the respective candidate route. The at least one memory and the computer program code of an example embodiment are further configured to, with the processor, cause the apparatus to cause transmission of the information to a user interface.

The at least one memory and the computer program code of an example embodiment are further configured to, with the processor, cause the apparatus to determine, based at least on the capability data of two or more vehicles, a combination of the two or more vehicles to be utilized to traverse one of the at least one candidate routes. In this example embodiment, each of the two or more vehicles is to be utilized for a different respective portion of the one candidate route. In some embodiments of the apparatus, the capability data comprises at least one of a cost value, a travel time, or one or more disengagement capabilities for the respective vehicle. In some embodiments of the apparatus, the autonomous transition region parameters include an indication of delay associated with one or more disengagement regions and the indication of delay further comprises one or more of a current disengagement index value, a disengagement start location, a severity categorization, a number of vehicles currently disengaged within the disengagement region, or a current wait time.

In a further example embodiment, an apparatus is provided that includes means for receiving a route request comprising an origin location and a destination location. The apparatus also includes means for determining, based at least on the route request, one or more candidate routes. The apparatus also includes means for analyzing, for a respective candidate route of the one or more candidate routes that has at least one autonomous transition region, such as at least one disengagement region, the respective candidate route based upon a plurality of autonomous transition region parameters, such as a plurality of disengagement region parameters. The apparatus also includes means for causing transmission of information relating to the respective candidate route based upon the analyzing of the respective candidate route and the plurality of autonomous transition region parameters, such as disengagement region parameters, associated therewith.

In some embodiments of the apparatus, the apparatus also includes means for determining a respective route transition score using one or more of the plurality of autonomous transition region parameters with respect to analyzing the respective candidate route based upon one or more autonomous transition region parameters.

The apparatus of an example embodiment also includes means for determining, for at least one candidate route following determination of the respective route transition score using the one or more autonomous transition region parameters, an updated one or more autonomous transition region parameters. The apparatus of an example embodiment also includes means for determining an updated route transition score for the at least one candidate route based on the updated one or more autonomous transition region parameters. In some embodiments of the apparatus, the updated route transition score is determined in response to an autonomous level transition of one or more vehicles associated with the candidate route.

The apparatus of an example embodiment also includes means for causing, based on the one or more candidate routes, information to be provided regarding one or more vehicles. The information comprises capability data of a respective vehicle to maneuver the respective candidate route. The apparatus of an example embodiment also includes means for causing transmission of the information to a user interface.

The apparatus of an example embodiment also includes means for determining, based at least on the capability data of two or more vehicles, a combination of the two or more vehicles to be utilized to traverse one of the at least one candidate routes. In this example embodiment, each of the two or more vehicles is to be utilized for a different respective portion of the one candidate route. In some embodiments of the apparatus, the capability data comprises at least one of a cost value, a travel time, or one or more disengagement capabilities for the respective vehicle. In some embodiments of the apparatus, the autonomous transition region parameters include an indication of delay associated with one or more disengagement regions and the indication of delay further comprises one or more of a current disengagement index value, a disengagement start location, a severity categorization, a number of vehicles currently disengaged within the disengagement region, or a current wait time.

In a further example embodiment, a computer program product is provided that includes a non-transitory computer readable medium having program code portions stored thereon with the program code portions being configured, upon execution, to receive a route request comprising an origin location and a destination location. The program code portions are also configured to determine, based at least on the route request, one or more candidate routes. The program code portions are also configured to, for a respective candidate route of the one or more candidate routes that has at least one autonomous transition region, such as at least one disengagement region, analyze the respective candidate route based upon a plurality of autonomous transition region parameters, such as a plurality of disengagement region parameters. The program code portions are also configured to cause transmission of information relating to the respective candidate route based upon the analyzing of the respective candidate route and the plurality of autonomous transition region parameters, such as the plurality of disengagement region parameters, associated therewith.

The program code portions of an example embodiment are also configured to determine a respective route transition score using one or more of the plurality of autonomous transition region parameters with respect to analyzing the respective candidate route based upon a plurality of autonomous transition region parameters.

The program code portions of an example embodiment are also configured to determine, for at least one candidate route following determination of the respective route transition score using the one or more autonomous transition region parameters, an updated one or more autonomous transition region parameters. The program code portions of an example embodiment are also configured to determine an updated route transition score for the at least one candidate route based on the updated one or more autonomous transition region parameters. In some embodiments of the computer program product, the updated route disengagement score is determined in response to an autonomous level transition of one or more vehicles associated with the candidate route.

The program code portions of an example embodiment are also configured to, based on the one or more candidate routes, cause information to be provided regarding one or more vehicles. The information comprises capability data of a respective vehicle to maneuver the respective candidate route. The program code portions of an example embodiment are also configured to cause transmission of the information to a user interface.

The program code portions of an example embodiment are also configured to determine, based at least on the capability data of two or more vehicles, a combination of the two or more vehicles to be utilized to traverse one of the at least one candidate routes. In this example embodiment, each of the two or more vehicles is to be utilized for a different respective portion of the one candidate route. In some embodiments of the computer program product, the capability data comprises at least one of a cost value, a travel time, or one or more disengagement capabilities for the respective vehicle. In some embodiments of the computer program product, the autonomous transition region parameters include an indication of delay associated with one or more disengagement regions and the indication of delay further comprises one or more of a current disengagement index value, a disengagement start location, a severity categorization, a number of vehicles currently disengaged within the disengagement region, or a current wait time.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a flowchart illustrating the operations performed, such as by the apparatus of FIG. 1, in order to determine a respective route transition score for one or more candidate routes in accordance with an example embodiment;

FIG. 3 is a graphical representation of an example user interface including candidate routes and disengagement region parameters;

FIG. 4 is a flowchart illustrating the operations performed, such as by the apparatus of FIG. 1, in order to determine an updated route transition score in accordance with an example embodiment;

FIG. 5 is a flowchart illustrating the operations performed, such as by the apparatus of FIG. 1, in order to cause vehicle capability data to be transmitted to a user in accordance with an example embodiment; and

FIG. 6 is a graphical representation of an example user interface including indications of a plurality of vehicles and associated capability data.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

As described above, vehicles having autonomous functionalities (e.g., parking assist, lane change assist, lane keeping assist and/or the like) as well as fully autonomous vehicles (e.g., self-driving vehicles) have and will continue to improve conditions on roadways by reducing hazards such as distracted and/or impaired driving and other human errors. Such vehicles may be defined by a particular level of autonomy at which they operate. For example, a vehicle operating at “level 0” autonomy may issue warnings to a driver or may momentarily intervene but provides no sustained autonomous control. A vehicle operating “level 1” autonomy may provide features such that the driver and the automated system share control of the vehicle (e.g., cruise control, parking assist, lane keeping assist, etc.).

A vehicle operating at “level 2” autonomy may comprise an automated system which takes full control of the vehicle, including accelerating, braking, and steering. However, the driver must monitor the automated driving and be prepared to intervene immediately at a time when the automated system fails to respond properly. A vehicle operating at “level 3” autonomy may allow the occupant to turn their attention away from driving tasks. The “level 3” vehicle will handle situations that call for an immediate response, such as emergency braking. However, the driver must still be prepared to intervene within some limited time when called upon by the vehicle to do so.

A vehicle operating at “level 4” autonomy may require no driver attention for safety. For example, the occupant of the vehicle may sleep and/or leave the driver's seat during a commute. Further, a vehicle operating at “level 5” autonomy may require no human intervention at all. For example, the vehicle may, in some instances, be empty of occupants and be equipped to self-navigate. Examples may include a robotic taxi service and/or delivery service.

Usage of autonomous vehicles may further improve existing business models, such as ride share or taxi services. In this regard, autonomous vehicles may be utilized for ride share services, reducing the need for labor costs of human drivers and improving user experience of the ride share service. Further, autonomous vehicles may allow for more consistency and predictability so as to potentially reduce accidents and may be operated in a more efficient and cost-effective manner.

However, within certain regions along a route, a vehicle may require disengagement from autonomous functionality and a passenger within the vehicle to assume manual control or more manual control of the vehicle, at least until the region is traversed. Likewise, within certain other regions, the vehicle may re-engage to autonomous functionality, and/or change to a different, higher level of autonomy (e.g., from level 3 to level 4) and in some instances, the passenger may be required to direct the vehicle to resume autonomous control and/or change autonomy levels.

Although generally described herein to be a complete disengagement of autonomous functionality and the complete reliance upon manual control, an autonomous level transition more generally includes any change in autonomy level. In this regard, an autonomous level transition includes a change in the level of autonomy which in some embodiments results in a complete disengagement of autonomous functionality, but in other embodiments maintains some degree of autonomy with the level of autonomy changing (e.g., changing to a lower level of autonomy, referred to herein as a disengagement). Similarly, an autonomous level transition may be a change from a particular level of autonomy to a higher level of autonomy (e.g., from level 2 to level 4), referred to herein as an engagement.

Some examples of a region that requires disengagement from autonomous functionality (herein referred to as a disengagement region) may include a region under road works (e.g., under construction, having one or more lane closures, and/or the like), a high pedestrian traffic area (e.g., bus stops, school zone crossings, and/or the like), a region experiencing inclement conditions (e.g., black ice, etc.), a region having roadways with high curvature and/or slope, and/or a region that experiences a poor cellular signal, thereby limiting communication with the vehicle.

Some examples of a region in which a vehicle may re-engage autonomous functionality (e.g., from a manual mode to an autonomous mode) and/or perform an upward change in autonomy level may include a region such as a highway that includes straight paths and/or wide lanes, sparsely populated regions (e.g., country roads), regions having adequate and/or above average cellular coverage (e.g., 5G coverage) and/or the like. Such regions are herein referred to as engagement regions.

As further described below, although one or more autonomous vehicles will disengage upon entering a disengagement region, not all autonomous vehicles need disengage upon encountering a disengagement region as some autonomous vehicles are capable of maintaining autonomy under certain conditions, such as when experiencing inclement conditions, while other autonomous vehicles are not so capable. Similarly, although one or more autonomous vehicles will engage (e.g., change to a higher level of autonomy) upon entering or while within an engagement region, not all autonomous vehicles are capable of such higher levels of autonomy. For example, for some vehicles, the highest level of autonomy possible may be level 1 (e.g., vehicles having cruise control, parking assist, and the like, but no sustained self-driving capabilities). In this regard, such vehicles are not equipped to transition to a higher level of autonomy when in an engagement region allowing for, for example, level 3 autonomy.

Certain autonomous vehicles may be equipped to successfully traverse a particular disengagement region autonomously, while other autonomous vehicles may be required to disengage during traversal of the disengagement region. Thus, selection of a particular vehicle by a user to traverse a particular a route may greatly influence the user's ride experience. Continuing with the ride share service example above, a user embarking on a route having three disengagement regions and selecting an autonomous vehicle “A” is required to disengage and manually control the vehicle at all three disengagement regions, whereas if the user had selected autonomous vehicle “B,” the user would need not disengage at all, as autonomous vehicle “B” is equipped to autonomously traverse the three particular disengagement regions.

A method, apparatus and computer program product are provided in accordance with an example embodiment in order to facilitate autonomous vehicle selection based on the vehicle's ability to navigate autonomous transition regions along a particular route comprising at least one disengagement region. As described above, autonomous transition regions may comprise engagement regions and/or disengagement regions.

The apparatus that is configured to facilitate autonomous vehicle selection based on the vehicle's ability to navigate autonomous transition regions along a particular route comprising at least one autonomous transition region may be any of a wide variety of computing devices. For example, the apparatus may be embodied by a server, a computer workstation, a distributed network of computing devices, a personal computer, a navigation or mapping system, an advance driver-assistance system (ADAS) or any other type of computing device.

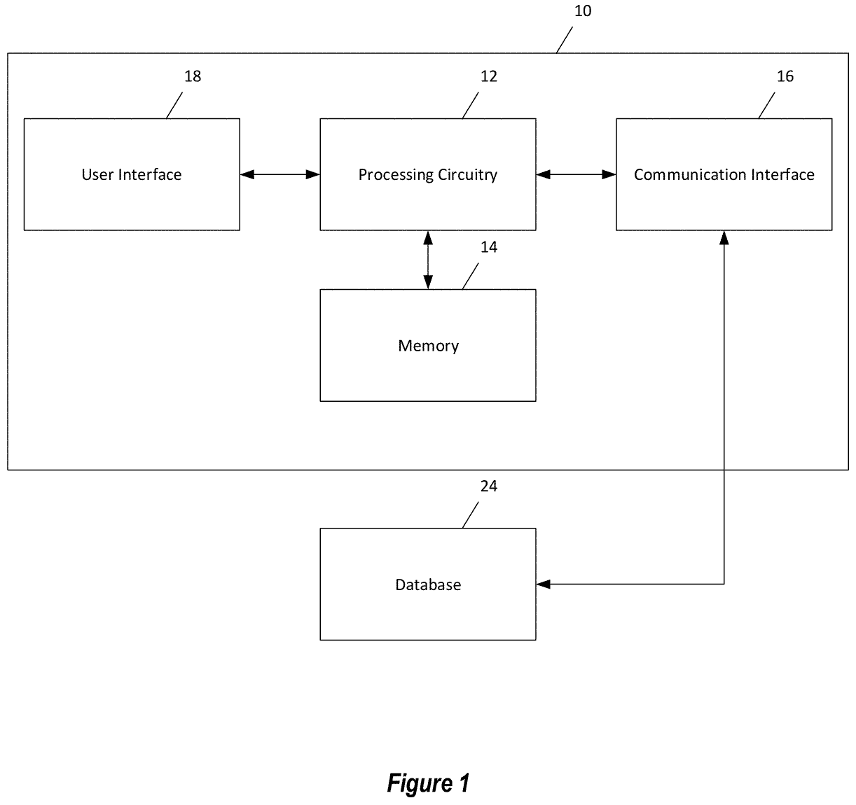

Regardless of the manner in which the apparatus is embodied, however, the apparatus 10 includes, is associated with, or is in communication with processing circuitry 12, memory 14, a communication interface 16 and optionally a user interface 18 as shown in FIG. 1. In some embodiments, the processing circuitry (and/or co-processors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., map data, route data, etc.) generated and/or employed by the processing circuitry 12. Additionally or alternatively, the communication interface can be configured to communicate in accordance with various wireless protocols including Global System for Mobile Communications (GSM), such as but not limited to Long Term Evolution (LTE). In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

The map database of database 24 may include node data, road segment data or link data, point of interest (POI) data, traffic data or the like. The map database may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database. As noted above, the map database accessed by an apparatus 10 of an example embodiment includes information regarding one or more map objects including information regarding the type of map object and the location of the map object.

The map database of database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database of database 24 may be a master map database, such as an HD map database, stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database of database 24 may be a master geographic database, but in alternate embodiments, a client side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

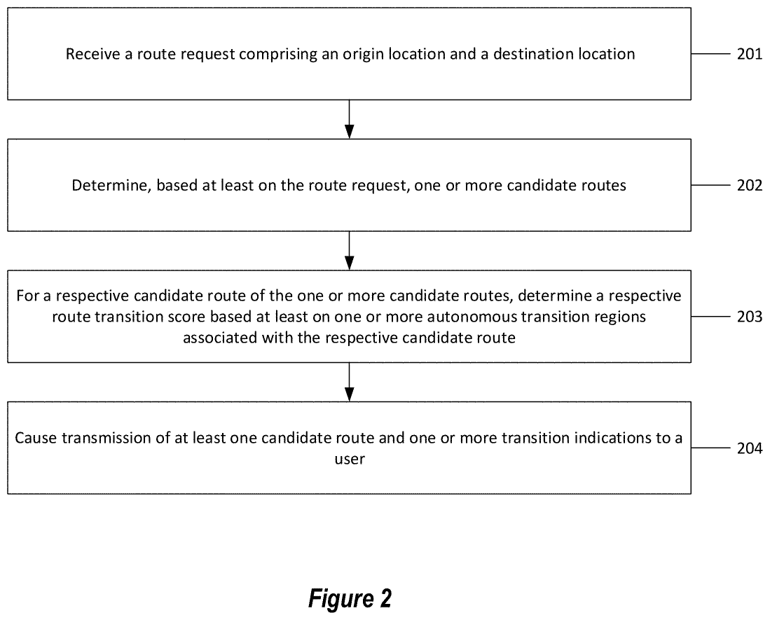

Referring now to FIG. 2, the operations performed, such as by the apparatus 10 of FIG. 1, in order to facilitate autonomous vehicle selection are depicted. As shown in block 201, the apparatus includes means, such as the processing circuitry 12, memory 14, the communication interface 16 or the like, for receiving a route request comprising an origin location and a destination location. In this regard, the route request may be received from an external source via the communication interface 16. In an embodiment, the route request may be received via the communication interface 16 from a user device, such as a mobile phone, laptop, and/or the like.

The route request may be received in response to a user desiring to embark on a particular journey to a destination and initiating the route request via a user device (e.g., a mobile phone or the like). The origin location and/or destination location may be a location (e.g., a pair of latitude and longitude coordinates) manually input by the user. In an embodiment, the origin location may represent a current location of the user.

As shown in block 202, the apparatus includes means, such as the processing circuitry 12, memory 14 or the like, for determining, based at least on the route request, one or more candidate routes. For example, using information from the route request, such as the origin location and destination location, the apparatus 16 may utilize the map database of database 24 described above to determine one or more candidate routes for the user to travel from the origin location to the destination location. The determined candidate route may also comprise information regarding a plurality of autonomous transition regions (e.g., engagement regions and disengagement regions) associated with the candidate route. The apparatus 10 may determine that a candidate route comprises one or more engagement regions and/or disengagement regions based on data previously collected and stored in database 24. For example, data from a plurality of vehicles previously collected over time and aggregated may be stored in database 24 and analyzed to determine one or more engagement regions and/or disengagement regions.

In an embodiment, for a respective candidate route of the one or more candidate routes that has at least one autonomous transition region, the apparatus includes means, such as the processing circuitry 12, memory 14 or the like, for analyzing the respective candidate route based upon a plurality of autonomous transition region parameters. The autonomous transition region parameters may be parameters associated with one or more engagement regions and/or one or more disengagement regions, herein referred to as engagement region parameters and disengagement region parameters, respectively.

With respect to disengagement regions, for a respective candidate route of the one or more candidate routes that has at least one disengagement region, the apparatus includes means, such as the processing circuitry 12, memory 14 or the like, for analyzing the respective candidate route based upon a plurality of disengagement region parameters. In this regard, the apparatus includes means, such as the processing circuitry 12, memory 14, the communication interface 16 or the like, for determining, for a respective disengagement region associated with the respective candidate route, a plurality of disengagement region parameters.

The plurality of disengagement region parameters determined by the apparatus may comprise one or more of a current disengagement index value, a disengagement start location, a severity categorization, a value representing a number of vehicles currently disengaged within the disengagement region, a value representing a current wait time, a disengagement reason, or the like.

A current disengagement index value may comprise a value on a scale (e.g., a value between 0 and 1) representative of a current condition of the associated disengagement region. For example, a higher current disengagement index may be indicative of a more severe condition of the disengagement region (e.g., a large amount of disengaged vehicles currently present within the disengagement region, inclement weather conditions present within the disengagement region, etc.). Conversely, a lower current disengagement index may be indicative of a less severe condition of the disengagement region (e.g., a small number of disengaged vehicles currently present within the disengagement region, short waiting times within the disengagement region, etc.). In addition to a current disengagement index value, a severity categorization may be determined based on the current disengagement index value. For example, the severity categorization may be a color-coded indication corresponding to the current disengagement index value. As one example, a high current disengagement index value (e.g., greater than 0.8) may correspond to a severity categorization of “red.” Likewise, a lower current disengagement index value (e.g., less than 0.3) may correspond to a severity categorization of “green.” In this regard, the severity categorization may provide a user-friendly and easily readable assessment of a particular candidate route. Further details regarding the disengagement index value are provided by U.S. patent application Ser. No. ______, filed ______, the entire contents of which are expressly incorporated by reference herein in their entirety.

The disengagement start location may be identified in various manners, but, in one embodiment, comprises a pair of latitude and longitude coordinates corresponding to a location at which the disengagement region begins. For example, the disengagement start location may define a location at which a vehicle disengages (e.g., transitions from a level of autonomy to a lower level of autonomy).

The value representing the number of vehicles currently disengaged within the disengagement region may be determined based on data from a plurality of disengaged vehicles within the disengagement region received by the apparatus and/or stored in database 24 or another computing device with which the apparatus is in communication. The value may be further based on timestamps associated with the received data. As an example, data received from vehicles that have not re-engaged autonomous functionalities and comprising timestamp values within a particular period of time (e.g., the previous hour) may be used to determine the value representing number of vehicles currently disengaged within the disengagement region. For example, the number of vehicles currently disengaged in the disengagement region may be 27 since of the 30 vehicles for which data has been received within the past hour indicating that autonomous functionalities have been disengaged, only 3 vehicles have re-engaged the autonomous functionalities.

The current wait time may comprise a value representing a length of time taken by a vehicle to exit the disengagement region after having disengaged autonomous functionalities upon entering the disengagement region. This value may be based on timestamped data received by the apparatus and/or stored in database 24 or other computing device from a plurality of vehicles that have traversed the disengagement region (e.g., vehicles that have disengaged upon entry into the disengagement region and re-engaged autonomous functionalities upon exiting the disengagement region). In an embodiment, the current wait time may be an averaged value based on wait times of a plurality of vehicles that have traversed the disengagement region. Other factors may contribute to the determination of the current wait time, such as a current number of vehicles currently disengaged within the disengagement region, weather conditions, and/or the like, relative to those same factors during the time period in which the averaged value was determined.

The disengagement reason may comprise a reason for which disengagement of autonomous functionalities is caused. The disengagement reason, when provided to a user interface, may provide a user-friendly and easily readable assessment of a particular candidate route. As one example, a disengagement reason may comprise a string text value “road works,” indicative that the disengagement region comprises an area under construction.

With respect to engagement regions, for a respective candidate route of the one or more candidate routes that has at least one engagement region, the apparatus includes means, such as the processing circuitry 12, memory 14 or the like, for analyzing the respective candidate route based upon a plurality of engagement region parameters. In this regard, the apparatus includes means, such as the processing circuitry 12, memory 14, the communication interface 16 or the like, for determining, for a respective engagement region associated with the respective candidate route, a plurality of engagement region parameters. For example, one or more engagement region parameters may be similar to the disengagement region parameters discussed above, such as a current index value, a start location, and/or the like. One additional example of an engagement region parameter may be a safety feature parameter. For example, a safety feature parameter may comprise data indicative of one or more safety features of the engagement region that enable engagements to take place within the region (e.g., an upward transition in autonomy level). Some examples of safety region parameters include indications of adequate or above average cellular coverage (e.g., 5G coverage), indications of suitable infrastructure within the engagement region to allow for engagements, and/or the like.

As shown in block 203, the apparatus includes means, such as the processing circuitry 12, memory 14 or the like, for determining, for a respective candidate route of the one or more candidate routes, a respective route transition score based at least on one or more autonomous transition regions associated with the respective candidate route. The route transition score may be based on one or more engagement regions, one or more disengagement regions, or a combination of both engagement regions and disengagement regions. For example, a route transition score based only on disengagement regions is referred to herein as a route disengagement score. Likewise, a route transition score based only on engagement regions is referred to herein as a route engagement score. In embodiments in which the route transition score is based on a combination of both engagement regions and disengagement regions of the route, the score may be referred to as a route transition score.

For example, a route disengagement score is representative of the extent by which one or more disengagements disrupt a route and may be determined in various manners. The following examples will describe determination of route disengagement parameters and a route disengagement score. However, similar methods may be employed to determine route engagement parameters and route engagement scores.

In an embodiment, a route disengagement score for a particular candidate route may be determined by using one or more disengagement region parameters associated with the candidate route. In an embodiment, a route disengagement score may be determined based upon a combination of current disengagement index values and average wait times of disengagement regions along the route. The current disengagement index values and average wait times of disengagement regions along the route may be combined in various manners including, for example, as a weighted average of current disengagement index values and average wait times of disengagement regions along the route. However, any disengagement region parameters, alone or in combination, may be used to determine a route disengagement score. As another example, a route disengagement score may be determined as a combination, e.g., weighted average, of the current disengagement index values and a number of vehicles currently disengaged within one or more disengagement regions.

As shown in block 204, the apparatus includes means, such as the processing circuitry 12, memory 14, the communication interface 16 or the like, for causing transmission of at least one candidate route and one or more transition indications, such as a route transition score or other information, to a user. A transition indication may comprise an indication of one or more autonomous region transition parameters. Continuing with the example above, transition indications may be the above-described color-coded severity categorizations for each disengagement region along the at least one candidate route. For example, the apparatus 10 may cause transmission of at least one candidate route and the associated route disengagement score to a user device that initiated the route request, such that the user is presented with information regarding the candidate route(s), for example, via a user interface.

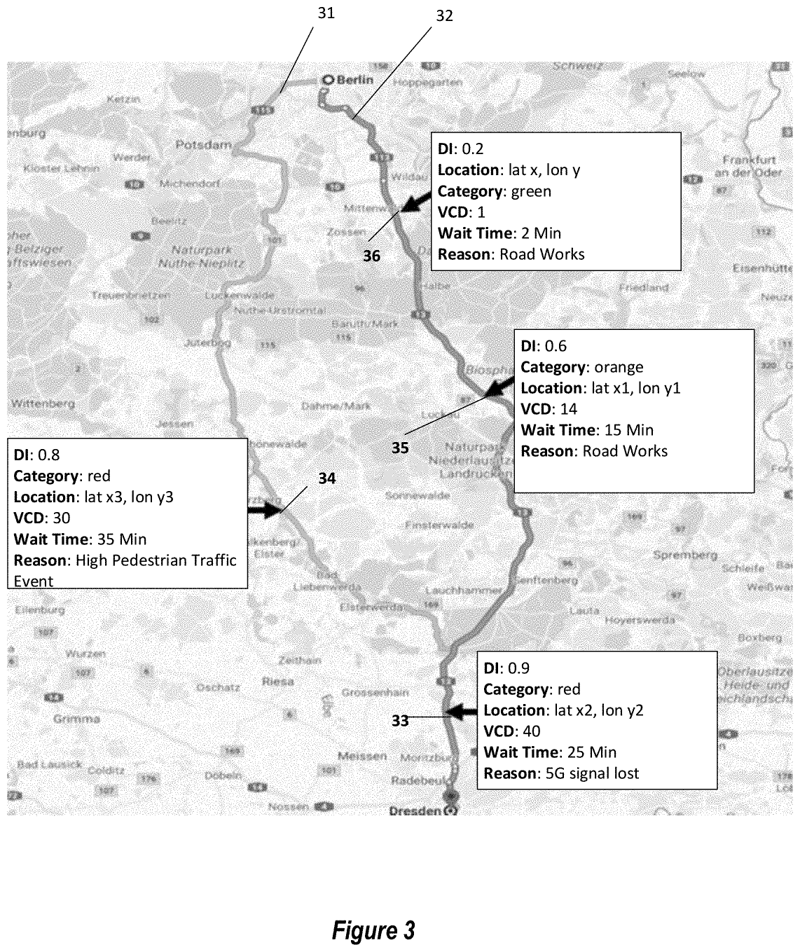

Turning to FIG. 3, an example of a user interface comprising indications of multiple candidate routes and associated disengagement region information is presented. As shown, two candidate routes are presented, left candidate route 31 and right candidate route 32. Both candidate routes represent optional routes a user may take for a route request comprising an origin location within Berlin and a destination location within Dresden. Information associated with a plurality of disengagement regions 33, 34, 35, and 36 along the candidate routes is also presented within the user interface of FIG. 3. The information in the depicted example includes a plurality of disengagement region parameters as described above, including a disengagement index value (DI), a severity categorization (“category”), a starting location (“location”), a number of vehicles currently disengaged (“VCD”), a current wait time (“wait time”), and a disengagement reason (“reason”). Though the example depicts these particular parameters, it is to be appreciated that more or fewer parameters may be transmitted to the user for display. For example, in an embodiment, only a severity categorization for each disengagement region may be transmitted to the user. In another embodiment, as described above, in addition to the candidate routes, only a route disengagement score may be transmitted to the user. In some embodiments, a user viewing the example user interface of FIG. 3 may be able to select a desired route from the user interface. For example, left candidate route 31 and right candidate route 32 may be user-selectable options (e.g., selectable via touch, mouse-click, etc.).

Using FIG. 3 as an example, in one embodiment, a route disengagement score may be determined as a weighted average of disengagement index (DI) values and average wait times. In this example, a route disengagement score (RDS) for the left candidate route 31 (having two disengagement regions 33 and 34) may be determined using the following formula:

(WT34*DI34+DI33*WT33)/(WT33+WT34)=RDS

(35*0.8+0.9*25)/(25+35)=0.84

wherein WT34 represents the current wait time of disengagement region 34 (e.g., 35 minutes), WT33 represents the current wait time of disengagement region 33 (e.g., 25 minutes), DI34 represents the disengagement index value of disengagement region 34 (e.g., 0.8), and DI33 represents the disengagement index value of disengagement region 33 (e.g., 0.9).

Similarly, a route disengagement score for the right candidate route 32 (having three disengagement regions 33, 35, and 36) may be determined using the following formula:

(WT33*DI33+DI35*WT35+DI36*WT36)/(WT33+WT35+WT36)=RDS

(2*0.2+0.6*15+25*0.9)/(2+15+25)=0.75

wherein WT35 represents the current wait time of disengagement region 35 (e.g., 15 minutes), WT36 represents the current wait time of disengagement region 36 (e.g., 2 minutes), DI35 represents the disengagement index value of disengagement region 35 (e.g., 0.6), and DI36 represents the disengagement index value of disengagement region 36 (e.g., 0.2).

Thus, despite the right candidate route 32 having a greater number of disengagement regions than left candidate route 31, right candidate route 32 has a lower route disengagement score. Provided with the information depicted in FIG. 3, a user is made aware of the number of disengagement regions on each candidate route along with the severities of each disengagement region. The user is now also aware of the route-based disengagement score which allows the user to now put the entire route into perspective for autonomous driving.

As described above, a route disengagement score for a particular candidate route may be determined by using one or more disengagement region parameters associated with the candidate route. As another example, a route disengagement score may instead be determined as a weighted average of the DI values and a current number of vehicles that are currently disengaged within one or more disengagement regions.

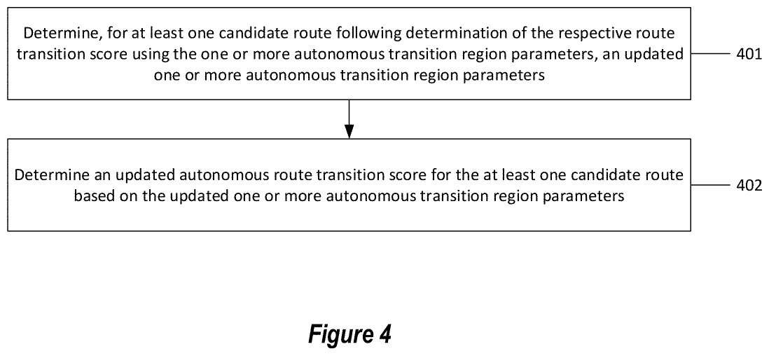

In some embodiments, the apparatus 10 may determine updated parameters for one or more autonomous transition regions. As shown in FIG. 4, at block 401, the apparatus includes means, such as the processing circuitry 12, memory 14 or the like, for determining, for at least one candidate route following determination of the respective route transition score using the one or more autonomous transition region parameters, an updated one or more autonomous transition region parameters. At block 402, the apparatus includes means, such as the processing circuitry 12, memory 14 or the like, for determining an updated route transition score for the at least one candidate route based on the updated one or more autonomous transition region parameters.

For example, updated route transition scores may be determined periodically by the apparatus 10, e.g., based on a preconfigured time interval. As one example, the apparatus 10 may determine an updated route transition score for a candidate route every 15 minutes. In some embodiments, the updated autonomous transition region parameters and/or updated route transition score may be provided to the user (e.g., via a user interface) for display. In this regard, the apparatus includes means, such as the processing circuitry 12, memory 14, the communication interface 16 or the like, for causing transmission of one or more updated autonomous transition region parameters and an associated updated route transition score to a user.

In some embodiments, updating of autonomous transition region parameters and/or route transition scores may be event-driven. For example, an updated route transition score may be determined in response to an autonomous level transition of one or more vehicles associated with the candidate route. An autonomous level transition may comprise a change in the autonomy level of the one or more vehicles traveling along the candidate route, such as a complete disengagement or re-engagement of the autonomous functionality or a change, e.g., reduction or increase, in the autonomous functionality. In this regard, route transition scores may be updated in or near real-time based on data received from one or more vehicles on the candidate route, such as based on an autonomous level transition.

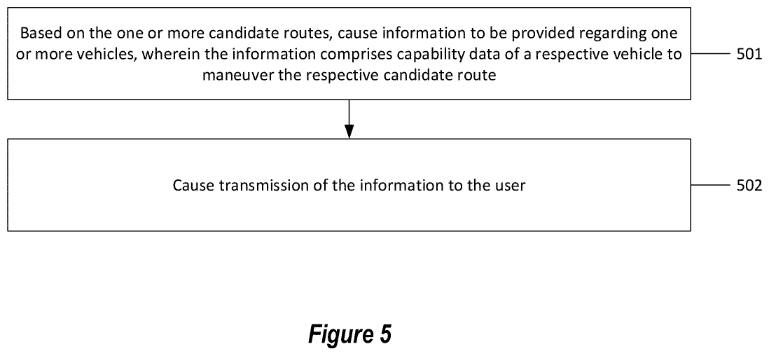

Turning to FIG. 5, example operations for causing vehicle capability data to be transmitted to a user are depicted. As shown in block 501, the apparatus includes means, such as the processing circuitry 12, memory 14, the communication interface 16 or the like, for causing information to be provided regarding one or more vehicles based on the one or more candidate routes. The information comprises capability data of a respective vehicle to maneuver the respective candidate route.

At block 502, the apparatus includes means, such as the processing circuitry 12, memory 14, the communication interface 16 or the like, for causing transmission of the information to a user.

In this regard, utilizing data stored in database 24 regarding a plurality of vehicles, the apparatus 10 may determine information associated with a set of vehicles which may be used to traverse the one or more candidate routes. For example, the information may comprise a listing of autonomous vehicles and their capabilities to cover each route, which may be presented to the user. In one embodiment, the listing may comprise a plurality of data in the form of tuples. Each tuple in the listing corresponds to a particular vehicle. Each tuple may comprise capability data regarding the autonomous driving capabilities within and/or around one or more engagement and/or disengagement regions of the one or more candidate routes for the particular vehicle associated with the tuple.

The capability data may comprise at least one of a cost value, a travel time, or one or more disengagement capabilities for the respective vehicle. For example, a cost value may represent a monetary cost the user may incur for selecting the vehicle and subsequently traversing one or more candidate routes with the vehicle. In some embodiments, the cost value may represent a flat-fee, or alternatively, the cost value may be based on a time usage of the vehicle, e.g., a cost-per-hour. In some embodiments, a cost value may be higher for certain vehicles, such as, for example, vehicles that are capable of autonomously traversing a higher number of disengagement regions and/or vehicles that are configured for a higher level of autonomy (e.g., level 4 and/or level 5 autonomy). The travel time may comprise an estimated time to be taken for the vehicle to traverse a respective candidate route. A disengagement capability for a respective vehicle may represent a disengagement reason (as described above) for a disengagement region which the vehicle is equipped to overcome. In other words, inclusion of a disengagement capability in the capability data may indicate that the vehicle is able to successfully autonomously traverse a disengagement region having a disengagement reason similar to the disengagement capability. As one example, capability data for a particular vehicle having disengagement capabilities including “road works” and “5G signal lost” indicates that the particular vehicle is able to autonomously traverse disengagement regions undergoing road work and regions lacking cellular coverage, respectively.

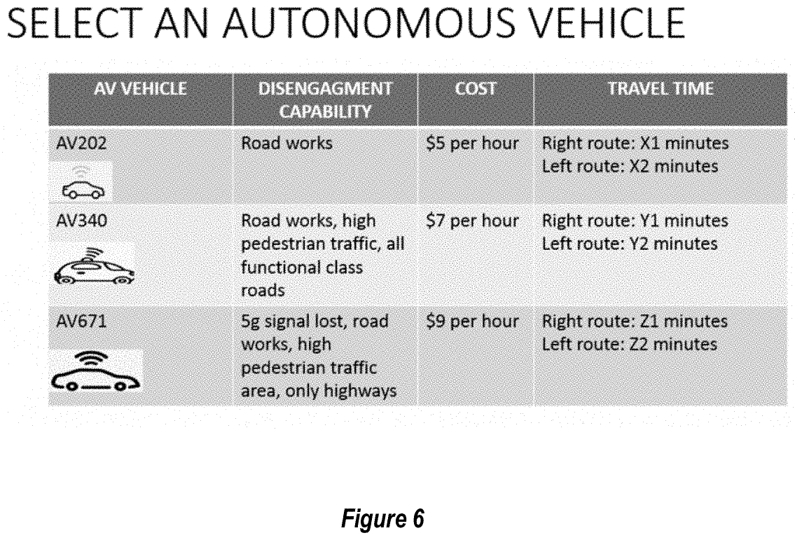

For example, FIG. 6 depicts an example listing rendered to a user interface in which a user may select a vehicle to traverse the candidate routes depicted in FIG. 3 (e.g., left candidate route 31 and right candidate route 32). As one example, the user may select an autonomous vehicle at the user interface to be utilized in conjunction with a ride share service. In some embodiments, a user viewing the example user interface of FIG. 6 may be able to select a desired autonomous vehicle from a listing presented on the user interface. For example, vehicles AV202, AV340, and AV671 may be user-selectable buttons (e.g., selectable via touch, mouse-click, etc.). As shown, three tuples are depicted for three different vehicles, AV202, AV340, and AV671. For each vehicle, one or more disengagement capabilities are listed, as well as a cost, and a travel time for each candidate route. As shown, AV671 represents a particular autonomous vehicle capable of autonomously traversing a greater variety of disengagement regions. For example, it is indicated that AV671 may autonomously traverse disengagement regions that lack a 5G signal, that are undergoing road works (e.g., construction), that are high pedestrian traffic areas, and that include at least some road segments that are other than highways.

In some embodiments, capability data may further comprise engagement capabilities, and for each vehicle presented at the user interface, one or more engagement capabilities may be listed as well. For example, engagement capabilities may comprise an indication of a highest level of autonomy at which vehicle is capable of performing for a particular candidate route and/or features that may cause other vehicles to disengage that will not cause the respective vehicle to disengage but that can, instead, be handled autonomously.

In some embodiments, the listing of the autonomous vehicle options may be a ranked listing. As one example shown in FIG. 6, the autonomous vehicles may be ranked by cost, with the listing beginning with AV202 as the least expensive option. Similarly, the autonomous vehicles may be ranked by their respective disengagement capabilities. In some embodiments, the listing may be updated based on a desired criteria. For example, the column headings may be user-selectable (e.g., via touch, mouse-click, etc.) such that selecting a column heading updates the ranking. In this regard, a user selecting the “cost” column heading may cause the ranking to be updated from a low-to-high cost ranking to a high-to-low cost ranking.

In some embodiments, the ranking may be based on a selected candidate route. For example, the ranked listing of autonomous vehicles may differ had the user selected the right candidate route 32 of FIG. 3 over the left candidate route 31. In this regard, selection of left candidate route 31 may cause the ranked listing to be based on disengagement capabilities associated with disengagement regions of the left candidate route 31, such that vehicles able to autonomously traverse all or a majority of the disengagement regions of left candidate route 31 are prioritized and presented at the top of the ranked listing.

In some embodiments, ranked listings for each candidate route (e.g., left candidate route 31 and right candidate route 32) may be presented at the user interface side-by-side, such that a user can compare the listings of vehicles along with the candidate routes.

The information provided at the user interface in FIG. 6 allows for a user to determine that if they select AV202, they will not have any issues and will not suffer from an autonomous level transition while navigating through road works, e.g., disengagement regions having construction zones. Thus, the user is able to deduce that if they were to select AV202 and traverse the right candidate route 32, they would be able to autonomously traverse disengagement regions 35 and 36, however may need to disengage or at least reduce the autonomous functionality (e.g., change to a lower autonomous level) during traversal of disengagement region 33 and manually maneuver the vehicle.

Further, the user may determine from the information provided that selecting AV202 and traversing the left candidate route 31 would not be ideal, given that AV202 cannot autonomously traverse disengagement regions having high pedestrian traffic or a loss of 5G signal. The user may also determine that vehicle AV671 can navigate both routes in a fully autonomous mode, however the vehicle has a greater cost value and therefore is more expensive to use compared to the other vehicles available.

In some embodiments, the apparatus includes means, such as the processing circuitry 12, memory 14 or the like, for determining, based at least on capability data of two or more vehicles, a combination of the two or more vehicles to be utilized to traverse a candidate route. In this embodiment, each of the two or more vehicles is to be utilized for a different respective portion of the candidate route.

Using the right candidate route 32 route in FIG. 3 and the capability data in FIG. 6 as an example, it is assumed that it will take an average of two hours to traverse the right candidate route 32. If the user selects vehicle AV671, the user may traverse the entire route without becoming disengaged, but at the cost of $18.00 ($9.00*2 hours). However, the user may select autonomous vehicle AV202 for the first half of the journey (e.g., the first hour) since AV202 will not disengage in road work areas (e.g., disengagement regions 35 and 36) and then select vehicle AV671 for the latter half of the journey in order to autonomously traverse disengagement region 33. The cost for this multiple-vehicle journey is therefore $5.00+$9.00=$14.00, a cost savings of $4 over utilizing AV671 for the entire journey. In this regard, the apparatus may determine two or more vehicles to be utilized in combination for a particular route in order to provide a cost savings mechanism to the user. In some embodiments, cost savings may also be caused to be transmitted to the user for display.

In some embodiments, the cost value for a particular vehicle utilized for a journey may be reassessed by the processing circuitry 12 based on particular events during the journey. For example, a cost may be adjusted based on a usage of one or more autonomous capabilities. For example, a cost reduction may be imposed in an instance in which one or more autonomous capabilities are not actually utilized during the journey. In another example, a cost reduction may be imposed in an instance in which the autonomous vehicle fails to autonomously traverse a disengagement region or perform at a level of autonomy (e.g., within an engagement region) which the capability data associated with the autonomous vehicle that was provided to the user indicated that the vehicle would be capable of doing. In this regard, the apparatus includes means, such as the processing circuitry 12, memory 14 or the like, for determining an adjusted cost value based on one or more events associated with the candidate route.

FIGS. 2, 4 and 5 illustrate flowcharts depicting a method according to an example embodiment of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory storing computer program code, the at least one memory and the computer program code configured to, with the processor, cause the apparatus to at least:
receive a route request comprising an origin location and a destination location;
determine, based at least on the route request, one or more candidate routes;
for a respective candidate route of the one or more candidate routes, determine a respective route disengagement score based at least on one or more disengagement regions associated with the respective candidate route; and
cause transmission of at least one candidate route and one or more transition indications to a user interface.

2. The apparatus according to claim 1, wherein the at least one memory and the computer program code are further configured to, with the processor, cause the apparatus to:
determine, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason,
wherein the respective route disengagement score is determined using one or more of the disengagement region parameters.

3. The apparatus according to claim 2, wherein the at least one memory and the computer program code are further configured to, with the processor, cause the apparatus to:
determine, for at least one candidate route following determination of the respective route disengagement score using the one or more disengagement region parameters, an updated plurality of disengagement region parameters; and
determine an updated route disengagement score for the at least one candidate route based on the updated plurality of disengagement region parameters.

4. The apparatus according to claim 3, wherein the updated route disengagement score is determined periodically based on a preconfigured time interval.

5. The apparatus according to claim 3, wherein the updated route disengagement score is determined in response to an autonomous level transition of one or more vehicles associated with the candidate route.

6. The apparatus according to claim 1, wherein the at least one memory and the computer program code are further configured to, with the processor, cause the apparatus to:
based on the one or more candidate routes, cause information to be provided regarding one or more vehicles, wherein the information comprises capability data of a respective vehicle to maneuver the respective candidate route; and
cause transmission of the information to the user.

7. The apparatus according to claim 6, wherein the at least one memory and the computer program code are further configured to, with the processor, cause the apparatus to:
based at least on the capability data of two or more vehicles, determine a combination of the two or more vehicles to be utilized to traverse one of the at least one candidate routes, wherein each of the two or more vehicles is to be utilized for a different respective portion of the one candidate route.

8. The apparatus according to claim 6, wherein the capability data comprises at least one of a cost value, a travel time, or one or more disengagement capabilities for the respective vehicle.

9. A method comprising:
receiving a route request comprising an origin location and a destination location;
determining, based at least on the route request, one or more candidate routes;
for a respective candidate route of the one or more candidate routes that has at least one autonomous transition region, analyzing the respective candidate route based upon one or more autonomous transition region parameters; and
causing transmission of information relating to the respective candidate route based upon the analyzing of the respective candidate route and the one or more autonomous transition region parameters associated therewith.

10. The method according to claim 9, wherein analyzing the respective candidate route based upon the one or more autonomous transition region parameters further comprises determining a respective route transition score using the one or more autonomous transition region parameters.

11. The method according to claim 10, further comprising:
determining, for at least one candidate route following determination of the respective route transition score using the one or more autonomous transition region parameters, an updated one or more autonomous transition region parameters; and
determining an updated route transition score for the at least one candidate route based on the updated one or more autonomous transition region parameters.

12. The method according to claim 11, wherein the updated route transition score is determined in response to an autonomous level transition of one or more vehicles associated with the candidate route.

13. The method according to claim 9, further comprising:
based on the one or more candidate routes, causing information to be provided regarding one or more vehicles, wherein the information comprises capability data of a respective vehicle to maneuver the respective candidate route; and
causing transmission of the information to a user interface.

14. The method according to claim 13, further comprising:
based at least on the capability data of two or more vehicles, determining a combination of the two or more vehicles to be utilized to traverse one of the at least one candidate routes, wherein each of the two or more vehicles is to be utilized for a different respective portion of the one candidate route.

15. The method according to claim 13, wherein the capability data comprises at least one of a cost value, a travel time, or one or more disengagement capabilities for the respective vehicle.

16. The method according to claim 9, wherein the autonomous transition region parameters comprises an indication of delay associated with one or more disengagement regions, the indication of delay comprising one or more of a current disengagement index value, a disengagement start location, a severity categorization, a number of vehicles currently disengaged within the one or more disengagement region, or a current wait time.

17. A computer program product including a non-transitory computer readable medium having program code portions stored thereon with the program code portions being configured, upon execution, to:
receive a route request comprising an origin location and a destination location;
determine, based at least on the route request, one or more candidate routes;
for a respective candidate route of the one or more candidate routes, determine a respective route disengagement score based at least on one or more disengagement regions associated with the respective candidate route; and
cause transmission of at least one candidate route and one or more transition indications to a user interface.

18. The computer program product according to claim 18, wherein the program code portions are further configured to:
determine, for a respective disengagement region associated with the respective candidate route, a plurality of disengagement region parameters comprising one or more of a current disengagement index value, a disengagement start location, a severity categorization, a number of vehicles currently disengaged within the disengagement region, a current wait time, or a disengagement reason,
wherein the respective route disengagement score is determined using one or more of the disengagement region parameters.

19. The computer program product according to claim 17, wherein the program code portions are further configured to:
based on the one or more candidate routes, cause information to be provided regarding one or more vehicles, wherein the information comprises capability data of a respective vehicle to maneuver the respective candidate route; and
cause transmission of the information to the user.

20. The computer program product according to claim 19, wherein the program code portions are further configured to:
based at least on the capability data of two or more vehicles, determine a combination of the two or more vehicles to be utilized to traverse one of the at least one candidate routes, wherein each of the two or more vehicles is to be utilized for a different respective portion of the one candidate route.
